(19) United States
(12) Patent Application Publication
(10) Pub. No.: US 2009/0037760 A1
(43) Pub. Date: Feb. 5, 2009

(54) CIRCUIT ARRANGEMENT HAVING A PLURALITY OF COMMUNICATION INTERFACES

(75) Inventors: Marco Scheibe, Zorneding (DE); Christian Schneckenburger, Holzkirchen (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Neubiberg (DE)

(21) Appl. No.: 12/183,197

(22) Filed: Jul. 31, 2008

(30) Foreign Application Priority Data
Jul. 31, 2007 (DE) 10 2007 035 808.5

(51) Int. Cl. G06F 1/08

(52) U.S. Cl. 713/501; 713/500

(57) ABSTRACT

A circuit arrangement including at least two communication interfaces, a clock input, a frequency divider, and a frequency comparator configured to compare a frequency applied to the clock input with a reference frequency, and to output a comparison signal, wherein based on the comparison signal, the circuit arrangement is configured to divide the frequency applied to the clock input and to activate a communication interface of the at least two communication interfaces.

### FIELD OF THE INVENTION

The invention relates to a circuit arrangement having at least two activatable communication interfaces.

### BACKGROUND

In many areas of engineering, special interface standards have now been developed so that electronic devices can communicate with one another. In this context, the V.24 standard or the RS232 standard for connecting printers and external devices to a computer are known, for example, from computer technology.

Another standard which is now very widespread is the USB standard, which allows devices to communicate with one another at high transmission rates using serial data transmission.

In the area of chip card technology, the interface based on ISO 7816, which is subsequently referred to as ISO for short, is widespread. This is used for a very wide variety of contact-based chip cards, for example for telephone cards, which have been known for a long time, widely used health insurance cards or else cash cards, which are being used to an increasing extent.

In the field of chip card technology, the USB standard is likewise known for data interchange, but this has not been used for data interchange between a chip card and a reader to date, since the readers usually only support the ISO 7816 standard.

One known solution to allow chip cards to be operated with ISO and USB interfaces is to use contacts C4 and C5 from the eight-contact chip card contact based on ISO 7816, which are reserved for additional services, for the D+ and D− lines based on the USB standard. In the case of a six-contact ISO connection, contacts C3 and C7 are provided for the USB data lines D+ and D−.

It is also known practice to use an additional pin for changing over between communication standards or to identify the signal levels on the dedicated interface lines (particularly D+/D− in the case of USB).

### DETAILED DESCRIPTION OF THE DRAWING

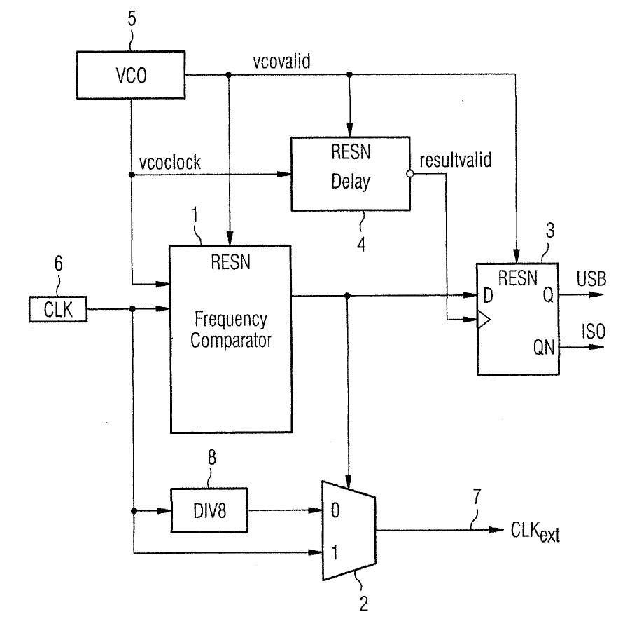

FIG. 1 shows a circuit arrangement according to an embodiment of the present invention.

### DESCRIPTION OF THE INVENTION

The invention provides a circuit arrangement having at least two activatable communication interfaces and also a method for activating and operating a communication interface in such a circuit arrangement, wherein operation on the basis of at least two standards is possible with little outlay and with a high level of flexibility.

A circuit arrangement in an embodiment of the invention has at least two communication interfaces, a clock input, a frequency divider, and a frequency comparator configured to compare a frequency applied to the clock input with a reference frequency, and to output a comparison signal, wherein based on the comparison signal, the circuit arrangement is configured to divide the frequency applied to the clock input and to activate a communication interface of the at least two communication interfaces.

In a method for activating a communication interface in a circuit arrangement having at least two communication interfaces, a clock input, a frequency divider and a frequency comparator according to an embodiment of the invention, the method includes comparing, by the frequency comparator, a frequency applied to the clock input with a reference frequency, activating one of the at least two communication interfaces based on the result of the comparison, and dividing the frequency applied to the clock input based on the result of the comparison.

In addition, the frequency comparator in the circuit arrangement may have a counter which is part of a phase-coupled control loop. The counter can be used in the phase-coupled control loop as a frequency divider. By way of example, provision may be made for the counter to be used as a frequency divider in a first mode of operation, in which the control loop produces a clock for operating the circuit arrangement, and to be used as a counter for the frequency comparison in a second mode of operation, in which a communication interface is activated.

In another advantageous refinement, the phase-coupled control loop has an adjustable oscillator which is used in a freewheeling state as a time base used for the comparison. In this case too, two modes of operation may be provided, wherein in one the oscillator is used as part of the phase-coupled control loop and in the other the oscillator is used in a freewheeling state as a time base.

Advantageously, the frequency comparator in the circuit arrangement is in a form such that it can take the applied frequency at the clock input as a basis for identifying at least two frequency ranges or for distinguishing which of at least two frequency ranges contains the frequency of a clock applied to the clock input.

Another feature of the circuit arrangement is that the frequency comparator is in a form such that the frequency ranges to be identified can be set as desired.

In this case, a communication interface in the circuit arrangement may advantageously be based on a USB standard (both standard USB and interchip USB).

Another communication interface in the circuit arrangement may advantageously be based on the ISO/IEC 7816 standard.

The communication interfaces may have common connections for making contact. This allows the number of connections needed to be reduced.

The block diagram in FIG. 1 shows an arrangement for a circuit arrangement for automatically activating a communication interface.

The circuit arrangement in FIG. 1 comprises a frequency comparator 1, a delay circuit 4, a frequency divider 8, a multiplexer 2, a clock input 6, a clock output 7, an interface register 3 and a voltage-controlled oscillator or VCO 5. The interface register 3 is in the form of a D-type flipflop having a data input, a clock input, a reset input and a data output with two data lines Q and QN which behave in complementary fashion with respect to one another. The data line Q becomes logic 1 when the USB interface is activated, and the data line QN becomes logic 1 when the ISO interface is activated. In the exemplary embodiment described, the circuit arrangement is part of a security controller for chip cards.

The input side of the frequency comparator 1 is connected to an output of the VCO 5 and to the clock input 6. The output of the frequency comparator 1 is connected to a control input of the multiplexer 2 and to the data input of the interface register 3.

In addition, the output of the VCO 5 is connected to the reset input of the interface register 3 via the delay circuit 4. In addition, the VCO 5 delivers a signal VCO-valid, which indicates whether the VCO frequency has been reached and is stable, to respective reset inputs of the delay circuit 4, of the interface register 3 and of the delay circuit 1. The effect achieved by this is that the delay circuit 4, the interface register 3 and the frequency comparator 1 cannot operate until the VCO frequency has been reached and is stable.

The clock input 6 is connected to one input of the multiplexer 2 directly and to another input of the multiplexer 2 via the frequency divider 8, which has a division ratio of eight. The output of the multiplexer 2 is connected to the clock output 7.

The VCO 5 is used as the internal time base in order to measure the frequency applied to the clock input 6. If the frequency applied to the clock input 6 exceeds a particular value then the circuit arrangement identifies that a USB interface or a USB frequency is involved. Otherwise, it is assumed that an ISO clock or an ISO interface is involved.

If a USB frequency is assumed, the frequency at the clock input 6 is divided by eight by means of the frequency divider 8, and if an ISO frequency is assumed, the frequency applied to the clock input 6 externally is maintained. To this end, when a USB frequency is assumed, the multiplexer 2 is used to select the frequency divided by the frequency divider 8 and forward it to the clock output 7. When an ISO frequency is assumed, the frequency is forwarded undivided.

As soon as the signal VCO-valid indicates a stable VCO frequency following start-up, the frequency comparator 1 takes the frequency of the clock signal from the VCO 5 and the frequency of a clock applied to the clock input 6 as a basis for producing a comparison result at the data input of the interface register 3. In addition, the delay circuit 4 produces a time-delayed signal at the clock input of the interface register 3 a certain time afterwards, so that the comparison result is transferred to the interface register 3 after a time delay.

The output of the interface register 3 produces the comparison result, which indicates whether the USB interface or the ISO interface needs to be activated. Since the frequency at the clock input 6 can assume different values and the circuit arrangement should be operated only up to a certain frequency, the standard path provided for a clock applied to the clock input 6 is the path via the frequency divider 8.

The delay circuit 4 produces the time-delayed signal only once, so that the interface register 3 can adopt the comparison result only once and is then unable to change over again until the next reset or the next start-up.

1. A circuit arrangement comprising:
at least two communication interfaces;
a clock input;
a frequency divider; and
a frequency comparator configured to compare a frequency applied to the clock input with a reference frequency, and to output a comparison signal,
wherein based on the comparison signal, the circuit arrangement is configured to divide the frequency applied to the clock input and to activate a communication interface of the at least two communication interfaces.

2. The circuit arrangement according to claim 1, wherein the frequency comparator comprises a counter and forms part of a phase-coupled control loop.

3. The circuit arrangement according to claim 2, wherein the phase-coupled control loop comprises an adjustable oscillator which is used as a time base for the reference frequency.

4. The circuit arrangement according to claim 1, wherein the frequency comparator is further configured to identify from at least two frequency ranges a frequency range including a frequency applied to the clock input.

5. The circuit arrangement according to claim 4, wherein the at least two frequency ranges are adjustable.

6. The circuit arrangement according to claim 1, wherein one of the communication interfaces is a USB interface.

7. The circuit arrangement according to claim 1, wherein one of the communication interfaces is an ISO-7816 interface.

8. The circuit arrangement according to claim 1, wherein the at least two communication interfaces comprise at least one common contact connection.

9. The circuit arrangement according to claim 1, wherein the circuit arrangement is configured such that in a phase of continuous operation a communication interface is activated only once.

10. The circuit arrangement according to claim 3, further comprising an interface register configured to forward from the frequency comparator the comparison signal, which indicates which of the at least two communication interfaces is to be activated.

11. The circuit arrangement according to claim 10, further comprising a delay circuit configured to input a time-delayed signal from the adjustable oscillator to a clock input of the interface register, such that the comparison signal is transmitted from the frequency comparator to the interface register after the time delay.

12. The circuit arrangement according to claim 10, wherein the interface register is a D-type flipflop.

13. The circuit arrangement according to claim 10, further comprising a multiplexer configured to select and forward to a clock output the divided frequency from the frequency divider if the comparison signal indicates that the frequency applied to the clock input is greater than the reference frequency.

14. The circuit arrangement according to claim 10, further comprising a multiplexer configured to select and forward to a clock output the frequency applied to the clock input without being divided if the comparison signal indicates that the frequency applied to the clock input is less than the reference frequency.

15. The circuit arrangement according to claim 11, wherein the adjustable oscillator is further configured to output to respective reset inputs of the delay circuit, the interface register, and the frequency comparator a valid signal when the voltage controlled oscillator frequency has been reached and is stable.

16. A security controller for chip cards comprising the circuit arrangement according to claim 1.

17. A method for activating a communication interface in a circuit arrangement having at least two communication interfaces, a clock input, a frequency divider and a frequency comparator, the method comprising:
comparing, by the frequency comparator, a frequency applied to the clock input with a reference frequency;
activating one of the at least two communication interfaces based on the result of the comparison; and
dividing the frequency applied to the clock input based on the result of the comparison.

18. The method according to claim 17, wherein the activating step comprises activating a USB interface if the frequency applied to the clock input is greater than the reference frequency.

19. The method according to claim 18, wherein the dividing step comprises dividing the frequency applied to the clock input by eight.

20. The method according to claim 17, wherein the activating step comprises activating an ISO interface if the frequency applied to the clock input is less than the reference frequency.

21. The method according to claim 20, wherein the frequency applied to the clock input is maintained without being divided.
